(19) United States
(12) Patent Application Publication
(10) Pub. No.: US 2009/0242523 A1
(43) Pub. Date: Oct. 1, 2009

(54) LASER PROCESSING METHOD

(75) Inventors: Kazuo Nakamae, Yokohama-shi (JP); Motoki Kakui, Yokohama-shi (JP); Shinobu Tamaoki, Yokohama-shi (JP)

Correspondence Address: VENABLE LLP, P.O. BOX 34385, WASHINGTON, DC, 20043-9998, US

(73) Assignee: Sumitomo Electric Industries, Ltd., Osaka-shi (JP)

(21) Appl. No.: 12/412,086

(22) Filed: Mar. 26, 2009

(30) Foreign Application Priority Data
Mar. 28, 2008 (JP) 2008-086591

(51) Int. Cl. B23K 26/20

(52) U.S. Cl. 219/121.64; 156/379.6; 156/272.8

(57) ABSTRACT

The present invention relates to a laser processing method that makes it possible to effectively suppress the generation of surface irregularities on the surface of a plastic member where a metal member and a plastic member are joined together. In the laser processing method, a plurality of laser beams are irradiated from different directions so as to focus on the vicinity of an interface between the metal member and the plastic member, which are in contact with one another. The power densities of the respective laser beams at this time are set to a level not more than a level, at which the exposed surface of the plastic member on the side opposite to the interface between the metal member and the plastic member, does not melt. As a result of this, air bubbles or the like are not generated in the vicinity of the exposed surface of the plastic member, and the generation of surface roughness on the exposed surface of the plastic member is effectively suppressed.

### BACKGROUND OF THE INVENTION

1. Field of the Invention

The present invention relates to a laser processing method of using laser irradiation to join together a metal member and a plastic member, which are dissimilar materials.

2. Related Background Art

As one method of processing an object using laser irradiation, a method for joining a metal member and a plastic member by irradiating a laser beam of a predetermined wavelength is known.

In “Laser-Assisted Metal and Plastic (LAMP) Joining,” Proceedings of the 4^{th} International Congress on Laser Advanced Materials Processing, Seiji Katayama et al (three others) (Non-patent Document 1), there is disclosed a method in which a plastic member comprising polyamide (PA), polyethylene terephthalate (PET), polycarbonate (PC) or polypropylene (PP) is placed on a stainless steel member (SUS) prepared as a metal member, and thereafter, the SUS and plastic member are fusion bonded by irradiating a laser in the vicinity of the interface between the SUS and the plastic member.

### SUMMARY OF THE INVENTION

The present inventors have examined the above conventional laser processing methods, and as a result, have discovered the following problems.

That is, in the above-mentioned Non-patent Document 1, laser irradiation is carried out in a state in which a plastic member with a thickness from 2 mm to 2.3 mm is placed on the stainless steel member. However, when attempting to use the technique disclosed in the above Non-patent Document 1 to join a stainless steel member to a plastic member that is thinner than the above-mentioned thickness (2 mm to 2.3 mm), the plastic region irradiated by the laser is heated intensively. The exposed surface of the plastic member (the surface that the laser beam touches directly) can melt at this time. Also, when the laser-induced heating progresses further in a state in which air bubbles have been formed in the vicinity of the exposed surface of the plastic member that has been locally heated by laser irradiation, the likelihood of these air bubbles growing too large and bursting increases. When an air bubble grows too large and bursts, an indentation caused by the burst bubble is formed inside the plastic member, causing the exposed surface of this plastic member to become concavo-convex (hereinafter referred to as surface irregularities). The problem is that when surface irregularities are formed in the plastic member like this, it not only causes defective appearance, but insulation failure as well.

The present invention has been developed to eliminate the problems described above. It is an object of the present invention to provide a laser processing method that makes it possible to effectively suppress the generation of surface irregularities in a plastic member when joining the plastic member to a metal member having dissimilar chemical properties.

In order to achieve the above-mentioned object, a laser processing method according to the present invention prepares a metal member and a plastic member, which are the targets for processing, places the plastic member on the metal member, and irradiates at least two laser beams (there can be three or more laser beams, which will simply be referred to as a plurality of laser beams hereinafter) from mutually different directions such that the respective focal points are positioned in the vicinity of the surface of the metal member, which constitutes the interface between the metal member and the plastic member.

The metal member has a first surface, which constitutes the direct-contact surface when the plastic member is put into place, and a second surface opposing the first surface. Further, the plastic member has a first surface, which constitutes the exposed surface, and a second surface opposing and constituting the direct-contact surface with the metal member when the plastic member is placed on the metal member. Therefore, by placing the plastic member on the metal member, the second surface of this plastic member makes contact with the first surface of the metal member.

The respective focal points of the plurality of laser beams are set in the vicinity of the interface between the metal member and the plastic member, that is, in the vicinity of the first surface of the metal member. Further, the respective power densities of the plurality of laser beams on the first surface of the plastic member are set equal to or less than a level at which the first surface of the plastic member does not melt.

In accordance with the laser processing method, a plurality of laser beams is irradiated from mutually different directions onto the vicinity of the interface between the metal member and the plastic member as described above, as a result of which the first surface of the metal member is heated, and, in addition, the plastic region adjacent to the heated metal region is melted. Consequently, the adhesion of the first surface of the metal member and the second surface of the plastic member increases, and the metal member and plastic member are joined together. By focusing the plurality of laser beams from mutually different directions in the vicinity of the first surface of the metal member at this time, the plurality of laser beams simultaneously irradiates a predetermined region of the metal member and the vicinity of the second surface of the plastic member, which is adjacent to this metal member, is sufficiently heated even when the light intensity of the respective laser beams is small. This makes it possible to join the metal member and the plastic member. Further, setting the light intensity of the plurality of laser beams to equal to or less than a level at which air bubbles are not generated in the surface of the plastic, that is, the level at which the second surface of the plastic member does not melt effectively suppresses the generation of surface irregularities on the second surface of the plastic member.

Furthermore, in the laser processing method according to the present invention, the plurality of laser beams that is irradiated onto the first surface of the metal member can also be generated by splitting a laser beam outputted from a single laser light source. A laser beam outputted from a single laser light source can easily be split into a plurality of directions. Therefore, in accordance with the laser processing method, a plurality of laser beams, the respective light intensities of which have been kept low, can simultaneously and easily be irradiated onto the first surface of the metal member, and the generation of surface irregularities in the plastic member can be effectively suppressed.

In the laser processing method according to the present invention, it is preferable that the irradiating plurality of laser beams be irradiated toward the first surface of the metal member such that the beam spots of two or more laser beams of the plurality of laser beams overlap either completely or partially on the first surface of the metal member. This makes it possible to efficiently heat the vicinity of the first surface of the metal member. Further, the incident directions of the plurality of laser beams can also be set such that the laser beams reach the first surface of the metal member after passing through the plastic member.

It is preferable that the plurality of laser beams be irradiated toward the first surface of the metal member such that the focal points thereof are positioned inside a region in which the distance from the interface of the metal member and the plastic member is equal to or less than ½ the thickness of the plastic member in a state in which the first surface of the metal member is in contact with the second surface of the plastic member. More specifically, for example, when joining a thin plastic member with a thickness of 0.4 mm or less to a metal member, it is preferable that the plurality of laser beams be irradiated toward the first surface of the metal member such that the focal points thereof are positioned inside a region in which the distance from the interface of the metal member and the plastic member is equal to or less than ½ the thickness of the plastic member, namely 200 μm or less, in a state in which the first surface of the metal member is in contact with the second surface of the plastic member. On the other hand, even when joining a plastic member with a thickness over 0.4 mm, for example 0.4 mm to several millimeters, to a metal member, surface irregularities in the plastic member can be effectively suppressed by setting the respective focal points of the plurality of laser beams within a region in which the distance from the interface between the metal member and the plastic member is 200 μm or less.

Further, in the laser processing method according to the present invention, it is preferable that the irradiating plurality of laser beams be irradiated toward the first surface of the metal member such that the focal points thereof are positioned inside the metal member. This makes it possible to more effectively heat the desired region of the metal member. Further, the irradiating plurality of laser beams can also be generated by splitting a laser beam outputted from a single laser light source. Furthermore, it is preferable that the irradiating plurality of laser beams has wavelengths different from each other. When the wavelengths of the irradiating laser beams differ, the respective absorption rates of the laser beams will differ in the metal member and the plastic member. Carrying out laser processing using a plurality of laser beams having wavelengths different from each other and mutually different absorption rates in the metal member and the plastic member makes it possible to select a laser beam having a wavelength that is suitable to the processing conditions. That is, it is possible to use a laser beam with a lower light intensity to more efficiently join the metal member and the plastic member.

In the laser processing method according to the present invention, it is preferable that the vicinity of the interface between the metal member and the plastic member, which is defined by the contact surface between the metal member and the plastic member, be heated from the metal member side. When joining the plastic member to a metal member that has high thermal conductivity, the heat is conducted inside the metal member by heating this metal member, and ultimately heating the plastic member, which is in contact with the metal member. Consequently, the joining of the metal member and the plastic member is carried out efficiently and easily even when using a laser beam having a light intensity such that the generation of air bubbles in the vicinity of the exposed surface of the plastic member is suppressed, that is, a laser beam of a power density that is set to equal to or less than a level at which the exposed surface of the plastic member does not melt. Therefore, since it is possible to carry out laser processing using a lower light intensity laser beam, the generation of surface irregularities in the plastic member is effectively suppressed.

In the laser processing method according to the present invention, it is preferable that the intensity distributions of the respective irradiating plurality of laser beams be made uniform in accordance with a diffractive optical element. This reduces the variations in light intensity between the respective laser beams. That is, it is possible to suppress surface irregularities in the plastic member since the generation of air bubbles in the exposed surface of the plastic member caused by variations in the light intensity of the laser beams is held in check.

The present invention will be more fully understood from the detailed description given hereinbelow and the accompanying drawings, which are given by way of illustration only and are not to be considered as limiting the present invention.

Further scope of applicability of the present invention will become apparent from the detailed description given hereinafter. However, it should be understood that the detailed description and specific examples, while indicating preferred embodiments of the invention, are given by way of illustration only, since various changes and modifications within the scope of the invention will be apparent to those skilled in the art from this detailed description.

### BRIEF DESCRIPTION OF THE DRAWINGS

FIG. 1 is a view for explaining a first embodiment of a laser processing method according to the present invention (Part 1);

FIG. 2 is a view for explaining the first embodiment of the laser processing method according to the present invention (Part 2);

FIGS. 3A to 3C are views for explaining the joining mechanism of a plastic member and a metal member;

FIG. 4 is a view for explaining a second embodiment of the laser processing method according to the present invention (Part 1);

FIG. 5 is a view for explaining the second embodiment of the laser processing method according to the present invention (Part 2);

FIG. 6 is a view for explaining a third embodiment of the laser processing method according to the present invention (Part 1);

FIG. 7 is a view for explaining the third embodiment of the laser processing method according to the present invention (Part 2); and

FIG. 8 is a view for explaining a fourth embodiment of the laser processing method according to the present invention.

### DESCRIPTION OF THE PREFERRED EMBODIMENTS

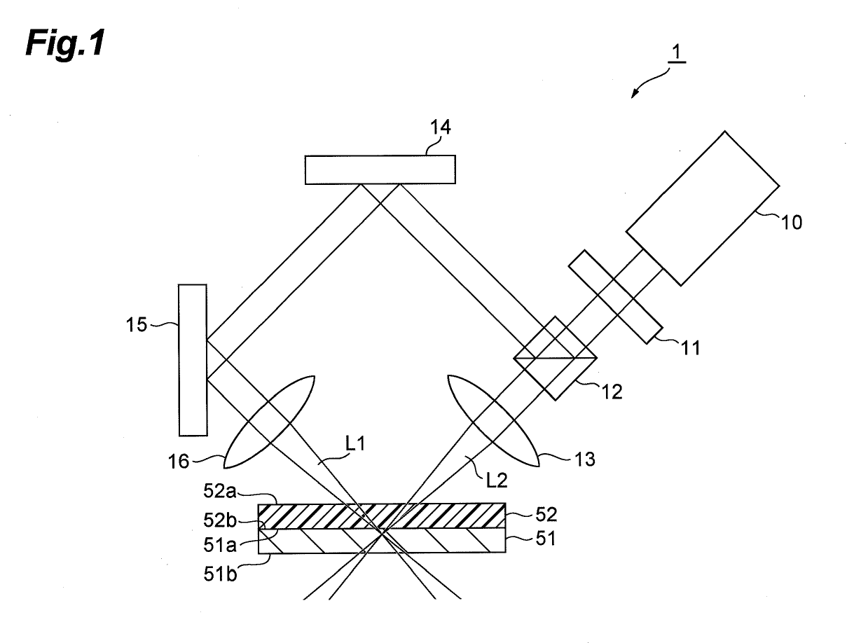

In the following, embodiments of the laser processing method according to the present invention will be explained in detail below by referring to FIGS. 1, 2, 3A-3C and 4-8. In the description of the drawings, identical or corresponding components are designated by the same reference numerals, and overlapping description is omitted.

### First Embodiment

FIG. 1 is a view for explaining a first embodiment of the laser processing method according to the present invention. The laser processing apparatus 1 shown in FIG. 1 comprises a laser light source 10, diffractive optical element (DOE) 11, beam splitter 12, first lens 13, first mirror 14, second mirror 15, and second lens 16. The laser processing apparatus 1 shown in this FIG. 1 splits a laser beam from the laser light source 10 into two, and irradiates these two laser beams onto an object to be processed comprising a metal member 51 and a plastic member 52 so as to focus the laser beams in the vicinity of the surface of the metal member 51. Furthermore, the metal member 51 has a first surface 51a, and a second surface 51b that is opposite this first surface 51a, and similarly, the plastic member 52 also has a first surface 52a, and a second surface 52b that is opposite this first surface. Therefore, when the object to be processed is constituted by placing the plastic member 52 on the metal member 51, the first surface 51a of the metal member 51 and the second surface 52b of the plastic member 52 make contact. Further, the interface between the metal member 51 and the plastic member 52 is defined by the contact surface between the first surface 51a of the metal member 51 and the second surface 52b of the plastic member 52.

The laser apparatus 10 in this first embodiment outputs a laser beam of a predetermined wavelength. For example, a YAG laser (30 W) is ideal as the laser light source 10. Furthermore, although not shown in FIG. 1, the diameter of the laser beam outputted from the laser light source 10 is expanded and collimated in accordance with a beam expander.

The DOE 11 is disposed between the laser light source 10 and the beam splitter 12. The DOE 11 inputs the laser beam outputted from the laser light source 10, and makes the light intensity within this inputted laser beam uniform. The laser beam for which the light intensity has been made uniform in the DOE 11 is outputted to the beam splitter 12. The beam splitter 12 functions to split the laser beam from the DOE 11, and outputs one portion of the laser beam L2 to the first lens 13 by allowing this laser beam L2 to pass through while outputting the remaining portion of the laser beam L1 to the first mirror 14 by reflecting the laser beam L1.

The first lens 13 functions as a light collection optical system for focusing the laser beam L2 that passed through the beam splitter 12. The laser beam L2 that passed through the beam splitter 12 is irradiated onto the object to be processed in accordance with this first lens 13. The first lens 13 utilized in the first embodiment has a focal distance of 50 mm. The first lens 13 is arranged such that the focal point thereof is in the vicinity of the surface of the metal member 51. Therefore, in a state in which the plastic member 52 has been placed on the metal member 51, the laser beam L2 outputted from the first lens 13 is focused in the vicinity of the interface (defined by the contact surface between the first surface 51a of the metal member 51 and the second surface 52b of the plastic member 52) between the metal member 51 and the plastic member 52.

The first mirror 14 once again reflects the laser beam L1 reflected (split) by the beam splitter 12 toward the second mirror 15. Further, the second mirror 15 reflects the laser beam L1 from the first mirror 14 toward the second lens 16.

The second lens 16 functions as a light collection optical system that focuses the laser beam L1 from the second mirror 15. The laser beam L1 that was reflected by the second mirror 15 is irradiated onto the object to be processed in accordance with this second lens 16. The second lens 16 utilized in the first embodiment has a focal distance of 50 mm. The second lens 16 is arranged such that the focal point thereof is positioned in the vicinity of the first surface 51a of the metal member 51. Therefore, in the state in which the plastic member 52 has been placed on the metal member 51, the laser beam L1 outputted from the second lens 16 is focused in the vicinity of the interface between the metal member 51 and the plastic member 52. The focal point of the laser beam L2 from the first lens 13 does not necessarily have to coincide with the focal point of the laser beam L1 from the second lens 16, but can be made coincident when the processing region is tiny.

The laser processing method that utilizes the laser processing apparatus 1 having a structure like that described above is carried out as follows. That is, the laser beam outputted from the laser light source 10 of the laser processing apparatus 1 passes through the DOE 11 and is split into two directions by the beam splitter 12. The laser beam L2 that passes directly through the beam splitter 12 is focused in the vicinity of the first surface 51a of the metal member 51 by the first lens 13. Conversely, the laser beam L1 that is outputted in the direction of the first mirror 14 by the beam splitter 12 is reflected by the first mirror 14 and the second mirror 15, and thereafter is focused in the vicinity of the first surface 51a of the metal member 51 by the second lens 16. As a result of this, the metal member 51 and the plastic member 52 are heated in the vicinity of the focal points of the two laser beams L1, L2. Consequently, the surfaces of the metal member 51 and the plastic member 52 are joined. Furthermore, the direction of the laser beam outputted from the laser light source 10 is changed by adjusting the arrangement of the laser light source 10, first lens 13, first mirror 14, second mirror 15 and second lens 16. Therefore, the respective focal points of the split laser beams L1, L2 can be changed by changing the arrangement thereof.

Further, in this first embodiment, the metal member 51, constituting a part of the object to be processed, is a plate-shaped stainless steel member (SUS) and has a thickness of 1 mm. Further, the plastic member 52, placed on the first surface 51a of the metal member 51, is comprised of polyethylene terephthalate (PET) and has a thickness of 0.4 mm.

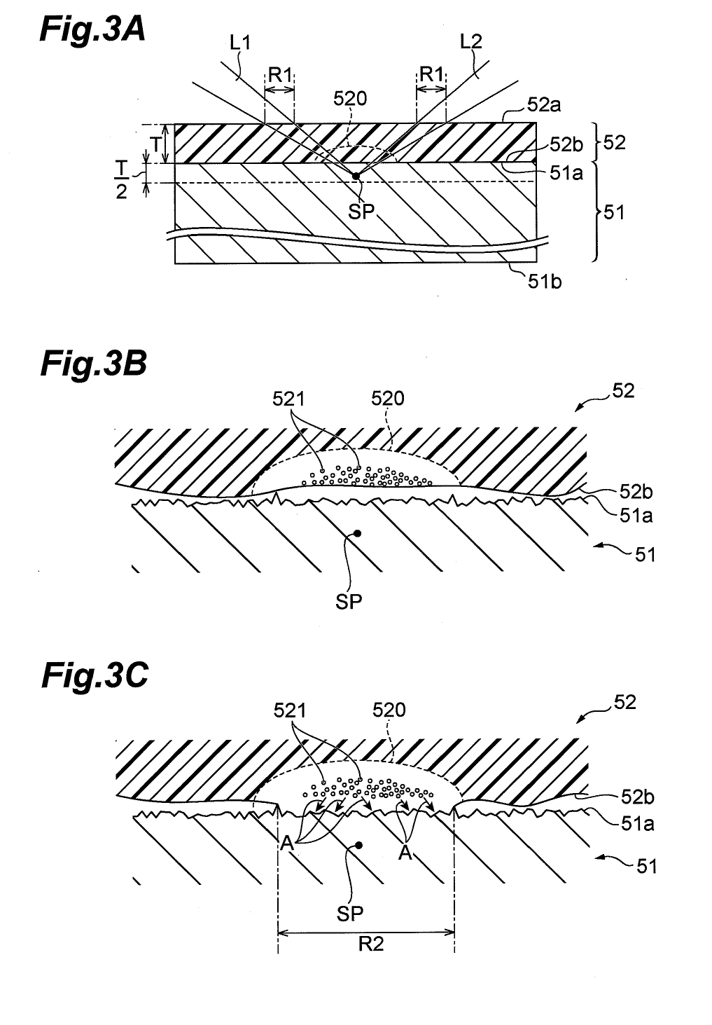

When focusing the laser beam on the object to be processed using the laser processing apparatus 1 having a structure like that described above, the laser beams L1, L2 respectively outputted from the first lens 13 and the second lens 16 are focused in the vicinity of the first surface 51a of the metal member 51. The light intensity increases in the vicinity of the first surface 51a of the metal member 51 where the laser beams L1, L2 are focused like this. The adjacent portion of the plastic member 52 is also heated at this time due to the heating of the metal member 51 in the vicinity of the focal points of the laser beams L1, L2 (air bubbles are generated by the heating of the inside of the plastic member 52). The air bubbles generated inside the plastic member 52 in the vicinity of the interface between the metal member 51 and the plastic member 52 push the resin surrounding these air bubbles out toward the first surface 51a of the metal member 51, thereby causing the first surface 51a of the metal member 51 to adhere tightly to the second surface 52b of the plastic member 52 (see FIGS. 3A to 3C). Meanwhile, as shown in FIG. 1, neither of the laser beams L1, L2 outputted from the first lens 13 and the second lens 16 are focused on the first surface 52a of the plastic member 52 as compared with the second surface 52b side, which is making contact with the first surface 51a of the metal member 51. Thus, it is clear that the power density of the laser beams L1, L2 is low at the first surface 52a of the plastic member 52.

Further, in this first embodiment, the laser beams L1, L2 outputted from the first lens 13 and the second lens 16 are focused in the vicinity of the first surface 51a of the metal member 51. When the laser beams L1, L2 outputted from the first lens 13 and the second lens 16 overheat the metal member 51 and plastic member 52 in the vicinity of the focal points at this time, the air bubbles generated in the plastic member 52 grow too much, causing these bubbles to burst. For this reason, the power densities of the respective laser beams L1, L2 outputted from the first lens 13 and the second lens 16 are controlled at the first surface 52a of the plastic member 52 so as not to melt the plastic member 52. That is, the light intensities of the laser beams L1, L2 at the first surface 52a of the plastic member 52 are extremely small compared to the vicinity of the focal points, suppressing the generation of air bubbles in the first surface 52a of the plastic member 52. Since the generation of air bubbles in the first surface 52a of the plastic member 52 at the time of laser irradiation is suppressed like this in the first embodiment, the generation of roughness (surface irregularities) in the first surface 52a (exposed surface) of the plastic member 52 can be effectively suppressed.

Furthermore, in this first embodiment, the focal points of the laser beams L1, L2 outputted from the first lens 13 and the second lens 16 are set in the vicinity of the first surface 51a of the metal member 51. In particular, the focal points can be in the vicinity of the interface between the metal member 51 and the plastic member 52 (the region located at a distance from the interface that is equal to or less than ½ the thickness of the plastic member 52), and specifically, it is preferable that the distance from the interface be no greater than 200 μm. In the first embodiment, since the plastic member 52 has a thickness of 0.4 mm, setting the focal points in either the metal member 51 or the plastic member 52 in the vicinity of the interface between the metal member 51 and the plastic member 52 makes it possible to lower the intensity of the laser beams at the first surface 52a (exposed surface) of the plastic member 52. Consequently, when the thickness of the plastic member 52 is over 0.4 mm, it is preferable to set the distance from the interface to ½ the thickness of the plastic member 52, in view of securing the adhesion between the plastic member 52 and the metal member 51. On the other hand, when the focal point is positioned within the metal member 51, the distance from the interface may be set to 200 μm or less without relation to the thickness of the plastic member 52.

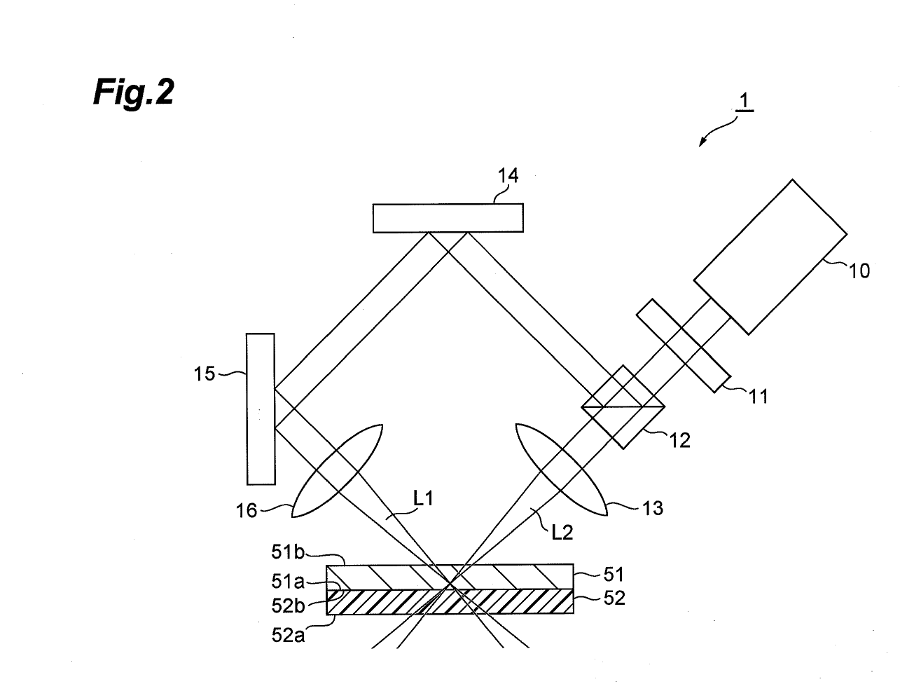

FIG. 2 is also a view for explaining the first embodiment of the laser processing method according to the present invention, and is a variation of the embodiment shown in FIG. 1. In FIG. 2, the constitution of the laser processing apparatus 1 itself is the same as in the laser processing shown in FIG. 1, but the constitution of the object to be processed is different. In particular, the object to be processed is constituted by placing the metal member 51 on the plastic member 52. The laser beams L1, L2 outputted from the first lens 13 and the second lens 16 are incident from the second surface 51b of the metal member 51, and focus in the vicinity of the first surface 51a of the metal member 51. Thus, in the laser processing apparatus 1 shown in FIG. 2, the interface between the metal member 51 and the plastic member 52 can also be irradiated from the metal member 51 side. Even in a variation such as this, the metal member 51 is heated by the irradiation of the laser beams L1, L2, and the adjacent portion of the plastic member 52 is heated by the heating of this metal member 51. Consequently, since air bubbles are generated within the adjacent region inside the plastic member 52, the surfaces of the metal member 51 and the plastic member 52 are firmly joined in the vicinity of the interface irradiated by the laser beams L1, L2. Further, in the embodiment shown in FIG. 2, since the laser beams L1, L2 do not focus on the first surface 52a of the plastic member 52, the generation of air bubbles in the vicinity of the first surface 52a (the exposed surface) of the plastic member 52 is suppressed, making it possible to effectively suppress surface irregularities in this plastic member 52.

Next, the mechanism for joining the metal member 51 and the plastic member 52 will be explained in detail using FIGS. 3A to 3C. Furthermore, FIG. 3A shows a state in which the plastic member 52 has been placed on the metal member 51. FIG. 3B is an enlarged view of the vicinity of the interface between the metal member 51 and the plastic member 52, which is heated by laser irradiation. FIG. 3C is an enlarged view of the vicinity of the interface between the metal member 51 and the plastic member 52, which is joined in accordance with laser irradiation.

First, as shown in FIG. 3A, the plastic member 52 is placed on the metal member 51. The interface between the metal member 51 and the plastic member 52 is defined at this time by the contact between the first surface 51a of the metal member 51 and the second surface 52b of the plastic member 52. Furthermore, either prior or immediately subsequent to the irradiation of the laser beam, a gap is created between the metal member 51 and the plastic member 52 as shown in FIG. 3B.

The laser beams L1, L2, which are irradiated toward the vicinity of the first surface 51a of the metal member 51 are respectively focused on the focal point SP. When the plastic member 52 has a thickness of T, the location of this focal point SP lies within the region up to T/2 toward the inside of the metal member 51 from the first surface 51a of the metal member 51. By positioning this focal point SP on the metal member 51 side, first, the metal member 51 itself is heated, and 20% of the adjacent region (heating region) of the plastic member 52 is heated by the heating of the metal member 51. The respective power densities of the laser beams L1, L2 at the laser irradiation regions R1 on the first surface 52a of the plastic member 52 at this time are such that this first surface 52a does not melt (levels at which air bubbles are not generated in the vicinity of the first surface 52a).

As the heating of the metal member 51 in accordance with the irradiation of the laser beams L1, L2 progresses, tiny air bubbles 521 are generated within the heating region 520 inside the adjacent plastic member 52 as shown in FIG. 3B. When tiny air bubbles 521 like this become numerous, these tiny air bubbles 521 push the surrounding plastic out in the direction denoted by the arrow A in FIG. 3C, that is, in the direction toward the first surface 51a of the metal member 51. As a result, it is believed that the plastic that has been pushed out by the generation of the tiny air bubbles 521 enters into irregularities formed in the first surface 51a of the metal member 51, thereby joining the surfaces of the metal member 51 and the plastic member 52 in region R2 (Refer to FIG. 3C).

### Second Embodiment

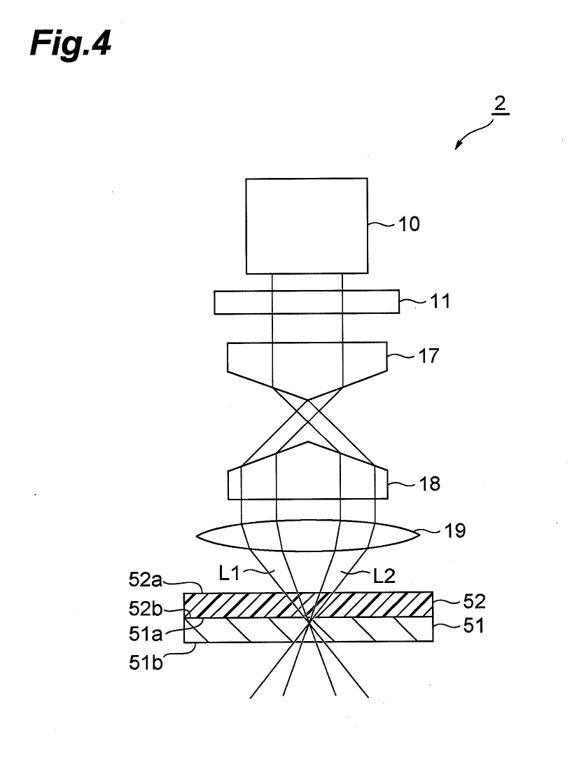

FIG. 4 is a view for explaining a second embodiment of the laser processing method according to the present invention. The laser processing apparatus 2 shown in FIG. 4 comprises a laser light source 10, DOE 11, first axicon lens 17, second axicon lens 18 and a lens 19. The laser processing apparatus 2 shown in FIG. 4 individually focuses a plurality of laser beams, and irradiates an object to be processed, which comprises a metal member 51 and a plastic member 52. Furthermore, in this second embodiment, the metal member 51 has a first surface 51a, and a second surface 51b that is opposite this first surface 51a, and the plastic member 52 also has a first surface 52a, and a second surface 52b that is opposite this first surface 52a. Therefore, when the object to be processed is constituted by placing the plastic member 52 on the metal member 51, the first surface 51a of the metal member 51 and the second surface 52b of the plastic member 52 make contact. Further, the interface between the metal member 51 and the plastic member 52 is defined by the contact between the first surface 51a of the metal member 51 and the second surface 52b of the plastic member 52.

The axicon lens is such that the one face through which the light is inputted/outputted is flat, and the other face has a conical shape. As shown in FIG. 4, the first axicon lens 17 outputs two laser beams L1, L2 from the conical-shaped part when a laser beam from the DOE 11 enters from the planar face. Conversely, the second axicon lens 18 is arranged facing the first axicon lens 17. This second axicon lens 18, upon the two laser beams L1, L2 from the first axicon lens 17 entering from the conical-shaped part, outputs the respective laser beams L1, L2 toward the lens 19 from the planar face. That is, as shown in FIG. 4, the optical paths of the two laser beams L1, L2 are changed by the conical-shaped part and outputted from the first axicon lens 17, and the laser beams L1, L2 outputted from the first axicon lens 17 are respectively incident on diagonal conical parts relative to the center of the conical-shaped part of the opposingly arranged second axicon lens 18, and thereafter are outputted toward the lens 19.

The lens 19 focuses the laser beams L1, L2 outputted from the second axicon lens 18 toward the object to be processed (irradiation of laser beams L1, L2). The focal length of the lens 19 used in this second embodiment is 50 mm. Further, the lens 19 is arranged such that the focal points are positioned in the vicinity of the interface between the metal member 51 and the plastic member 52. Therefore, the laser beams L1, L2 outputted from the lens 19 are focused in the vicinity of the interface between the metal member 51 and the plastic member 52.

The laser processing method that utilizes the laser processing apparatus 2 having a structure like that described above is as follows. That is, the laser beam outputted from the laser light source 10 of the laser processing apparatus 2 is inputted to the first axicon lens 17 by way of the DOE 11. The laser beams L1, L2, which had their optical paths changed by the first axicon lens 17, are inputted to the lens 19 by way of the second axicon lens 18. Then, by focusing the laser beams L1, L2 in the vicinity of the interface between the metal member 51 and the plastic member 52 in accordance with the lens 19, the vicinity of the interface between the metal member 51 and the plastic member 52 is heated. Consequently, the surfaces of the metal member 51 and the plastic member 52 are joined. Furthermore, the direction of the laser beam outputted from the laser light source 10 is changed by adjusting the arrangement of the laser light source 10, first axicon lens 17, second axicon lens 18 and lens 19. Changing the arrangements thereof also makes it possible to change the respective focal points of the laser beams L1, L2.

In this second embodiment, the plurality of laser beams L1, L2 is focused in the vicinity of the first surface 51a of the metal member 51 from mutual different directions. However, in comparison to the first embodiment, in the second embodiment, the optical path followed by the laser beam outputted from the laser light source 10 diverges after passing through the DOE 11.

When the laser beams L1, L2 are irradiated onto the object to be processed using the laser processing apparatus 2 of FIG. 4, the laser beams L1, L2 outputted from the lens 19 are focused in the vicinity of the first surface 51a of the metal member 51. Focusing the laser beams L1, L2 on the same location like this causes the light intensity at the focal point thereof to increase, and the metal member 51 is heated in the vicinity of the focal points of these laser beams L1, L2. Heating this metal member 51 also causes the adjacent portion of the plastic member 52 to be heated, and air bubbles are generated inside the plastic member 52. The air bubbles that are generated inside the plastic member 52 (the heating region 520) in the vicinity of the interface between the metal member 51 and the plastic member 52 push the plastic surrounding the air bubbles out toward the first surface 51a of the metal member 51, and the surfaces of the first surface 51a of the metal member 51 and the second surface 52b of the plastic member 52 are firmly joined together. Conversely, as shown in FIG. 4, it is clear that the laser light intensities of the laser beams L1, L2 outputted from the lens 19 are relatively low at the first surface 52a of the plastic member 52 compared to the vicinity of the second surface 52b (because the laser beams L1, L2 are not being focused on the first surface 52a). Therefore, the generation of air bubbles at the first surface 52a of the plastic member 52 is effectively suppressed, effectively suppressing the generation of surface irregularities in the plastic member 52.

Further, in this second embodiment, the irradiation area of the laser beams L1, L2 inputted from lens 19 expands as shown in FIG. 4 in accordance with the laser beams L1, L2 having gone by way of the first axicon lens 17 and the second axicon lens 18. In other words, the laser light intensity is lowered more than at the time the laser beam was outputted from the laser light source 10. Therefore, the laser light intensity is clearly lower (because the laser beam is not being focused) at the first surface 52a (the exposed surface) of the plastic member 52 than in the vicinity of the first surface 51a of the metal member 51. Thus, the heating effect on the metal member 51 and the plastic member 52 when the laser beams L1, L2 are individually irradiated is also lower, and the generation of air bubbles in the vicinity of the first surface 52a of the plastic member 52 is suppressed. Furthermore, since the laser processing apparatus 2 shown in FIG. 4 suppresses the generation of air bubbles in the first surface 52a of the plastic member 52 at laser beam irradiation, the generation of surface irregularities in the plastic member 52 is effectively suppressed.

Furthermore, by using axicon lens as in this second embodiment, the laser beam outputted from the same light source can be easily split into a plurality of laser beams. Further, the laser processing apparatus 2 having the effect described above can be readily manufactured.

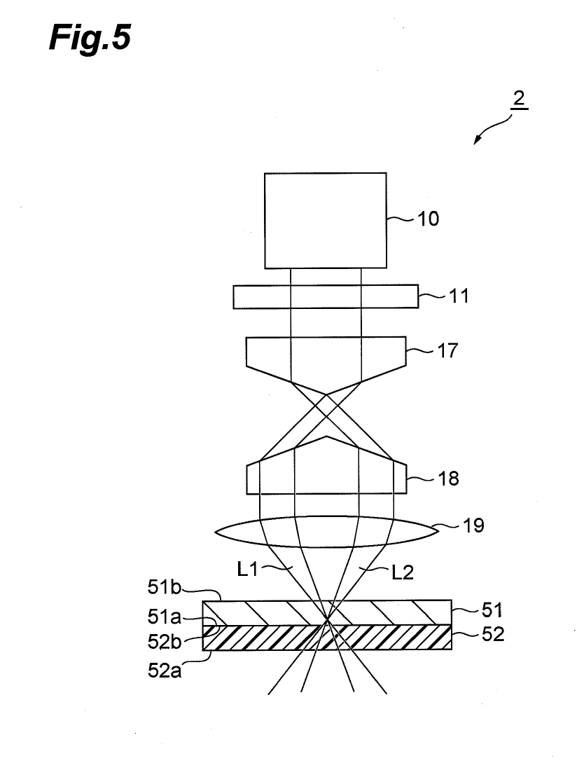

FIG. 5 is a variation of the laser processing method according to the second embodiment. In FIG. 5, the constitution of the laser processing apparatus 2 is the same, but the arrangement of the object to be processed is different compared to FIG. 4. That is, the metal member 51 is placed on the plastic member 52. The laser beams L1, L2 outputted from the lens 19 are incident from the second surface 51b of the metal member 51 at this time, and are focused in the vicinity of the first surface 51a of the metal member 51. Thus, in the laser processing apparatus 2 of FIG. 5, the embodiment can be one that heats the vicinity of the first surface 51a of the metal member 51 in accordance with laser irradiation from the second surface 51b side of the metal member 51. In this variation as well, the adjacent portion of the plastic member 52 is heated in accordance with the heating of the metal member 51, and tiny air bubbles are generated inside the plastic member 52. For this reason, the surfaces of the metal member 51 and the plastic member 52 are joined together in the vicinity of the focal points of the laser beams L1, L2. By contrast, since the laser beams L1, L2 are not focused in the vicinity of the first surface 52a of the plastic member 52, the generation of air bubbles in the vicinity of the first surface 52a is suppressed. As a result, the generation of surface irregularities in the plastic member 52 is effectively suppressed.

### Third Embodiment

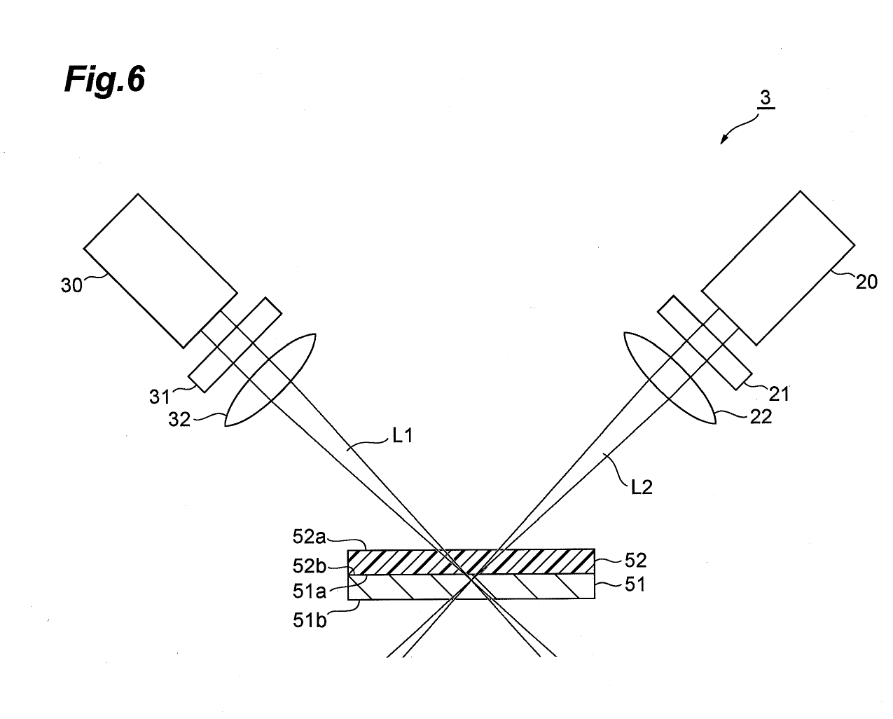

FIG. 6 is a view for explaining a third embodiment of the laser processing method according to the present invention. The laser processing apparatus 3 shown in FIG. 6 comprises a first laser light source 20, first DOE 21, first lens 22, second laser light source 30, second DOE 31 and second lens 32. Further, the laser processing apparatus 3 shown in FIG. 6 irradiates an object to be processed constituted from a metal member 51 and a plastic member 52 by individually focusing a plurality of laser beams. In this third embodiment as well, the metal member 51 has a first surface 51a, and a second surface 51b that is opposite this first surface 51a, and the plastic member 52 also has a first surface 52a, and a second surface 52b that is opposite this first surface 52a. Therefore, when the object to be processed is constituted by placing the plastic member 52 on the metal member 51, the first surface 51a of the metal member 51 and the second surface 52b of the plastic member 52 make contact. Further, the interface between the metal member 51 and the plastic member 52 is defined by the contact between the first surface 51a of the metal member 51 and the second surface 52b of the plastic member 52.

In this third embodiment, the first laser light source 20 outputs a laser beam L2. A YAG laser (15 W) is used as the first laser light source 20. Furthermore, although not shown in FIG. 6, the diameter of the laser beam L2 is expanded and collimated in accordance with a beam expander subsequent to being outputted from the laser light source 20.

Conversely, the second laser light source 30 outputs a laser beam L1 that has a different wavelength than the laser beam L2 outputted by the first laser light source 20. A CO₂ laser (10 W) is used as the second laser light source 30. Although not shown in FIG. 6, the diameter of the laser beam L1 is expanded and collimated in accordance with a beam expander subsequent to being outputted from the laser light source 30.

The first DOE 21 is disposed between the first laser light source 20 and the first lens 22. This first DOE 21 is inputted with the laser beam L2 outputted from the first laser light source 20, and makes the light intensity inside this laser beam L2 uniform. The laser beam L2 in which the light intensity has been made uniform in the first DOE 21 is outputted toward the first lens 22. Further, the second DOE 31 is disposed between the second laser light source 30 and the second lens 32. This second DOE 31 is inputted with the laser beam L1 outputted from the second laser light source 30, and makes the light intensity inside this laser beam L1 uniform. The laser beam L1 in which the light intensity has been made uniform in the second DOE 31 is outputted toward the second lens 32.

The first lens 22 focuses the laser beam L2 outputted from the first DOE 21 and irradiates this laser beam L2 onto the object to be processed. The focal length of the first lens 22 used in the third embodiment is 50 mm, and the first lens 22 is arranged so as to position the focal point thereof in the vicinity of the first surface 51a of the metal member 51. Therefore, the laser beam L2 outputted from the first lens 22 is focused in the vicinity of the first surface 51a of the metal member 51.

Similarly, the second lens 32 focuses the laser beam L1 outputted from the second DOE 31 and irradiates this laser beam L1 onto the object to be processed. The focal length of the second lens 32 used in the third embodiment is 50 mm. Further, the focal point of the laser beam L1 is in the vicinity of the first surface 51a of the metal member 51, and is coincident with the focal point of the first lens 22. Therefore, the laser beam L2 outputted from the first lens 22 and the laser beam L1 outputted from the second lens 32 are focused in the vicinity of the first surface 51a of the metal member 51.

The laser processing method according to the third embodiment, which utilizes the laser processing apparatus 3 having the above-described structure, is as follows. That is, in the laser processing apparatus 3, the laser beam L2 outputted from the first laser light source 20 sequentially passes through the first DOE 21 and the first lens 22, and is focused in the vicinity of the first surface 51a of the metal member 51. In the meantime, the laser beam L1 outputted from the second laser light source 30 sequentially passes through the second DOE 31 and the second lens 32, and is focused in the vicinity of the first surface 51a of the metal member 51 such that the focal point thereof is coincident with the focal point of the laser beam L2. By laser beams L1 L2 being focused on the same part like this, the vicinity of the first surface 51a of the metal member 51 is heated, and the adjacent portion of the plastic member 52 is also heated, thereby causing the surfaces of the metal member 51 and the plastic member 52 to join together.

In accordance with the third embodiment, the laser beams L1, L2 outputted from the first lens 22 and the second lens 32 are focused in the vicinity of the first surface 51a of the metal member 51 the same as in the above-described first embodiment and second embodiment. For this reason, a laser beam with a light intensity that adds the light intensities of both the laser beams L1, L2 is irradiated on the first surface 51a of the metal member 51. In the meantime, the laser beams L1, L2 are irradiated onto respectively different parts (the laser beams L1, L2 have different irradiation angles) of the first surface 52a (exposed surface) of the plastic member 52. For this reason, only the vicinity of the interface of the metal member 51 and the plastic member 52 is efficiently heated, and the surfaces of the two members 51, 52 are joined. Further, since respectively different parts of the first surface 52a of the plastic member 52 are irradiated by the laser beam L2 from the first lens 22 and the laser beam L1 from the second lens 32, the light intensities at the respective irradiated parts is extremely lower than at the focal point (the generation of air bubbles in the first surface 52a of the plastic member 52 is suppressed). Therefore, in accordance with the laser processing apparatus 3 shown in FIG. 6, the generation of air bubbles in the first surface 52a (exposed surface) of the plastic member 52 during laser processing is suppressed, thereby suppressing the generation of surface irregularities in the plastic member 52.

Further, in this third embodiment, different light sources, namely a first laser light source 20 (a YAG laser) and a second laser light source 30 (a CO₂ laser) are outputting laser beams L1, L2 of mutually different wavelengths. This makes possible laser processing that makes the most of laser beam characteristics obtained in accordance with different wavelengths.

In the laser processing apparatus 3, the laser beam L2 outputted from the first laser light source 20 (YAG laser) has a wavelength with higher energy absorption in the metal member 51 than in the plastic member 52. The metal member 51 can therefore be efficiently heated. Conversely, the laser beam L1 outputted from the second laser light source 30 (CO₂ laser) has a wavelength with higher energy absorption in the plastic member 52 than in the metal member 51. The plastic member 52 can therefore be efficiently heated. By making the most of these laser beam characteristics, for example, a processing method, which increases the output of the first laser light source 20 and heightens the strength of the outgoing laser beam L2 when heating the metal member 51 in advance, and outputs the laser beam L1 from the second laser light source 30 when heating the plastic member 52 subsequent to heating the metal member 51 to efficiently heat the plastic member 52, is conceivable. By using two different wavelength light sources while making adjustments like this, it is possible to join the metal member and the plastic member using laser beams of lower output. Therefore, even under conditions in which the plastic member 52 is thin and susceptible to the generation of air bubbles in the vicinity of the first surface 52a of the plastic member 52, reducing the output strength of the irradiated laser beams suppresses the generation of air bubbles, and resultantly can effectively suppress the generation of surface irregularities in the plastic member 52.

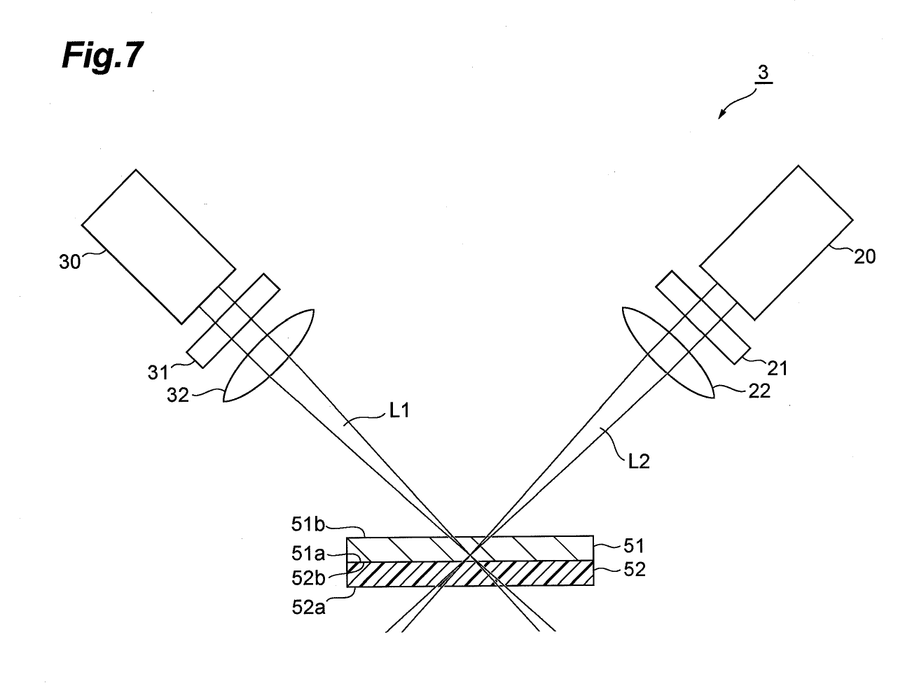

FIG. 7 is a variation of the laser processing method according to the third embodiment. In FIG. 7, the constitution of the laser processing apparatus 3 is the same, but the arrangement of the object to be processed is different than in the laser processing method shown in FIG. 6. That is, the object to be processed is constituted by placing the metal member 51 on the plastic member 52. Thus, the laser beams L1, L2 outputted from the first lens 22 and the second lens 32 are incident from the second surface 51b of the metal member 51, and are focused in the vicinity of the first surface 51a of the metal member 51. The laser processing apparatus 3 shown in FIG. 7 can also perform laser irradiation of the interface between the metal member 51 and the plastic member 52 from the side of the metal member 51 like this. In this variation, too, the adjacent portion of the plastic member 52 is heated and air bubbles are generated in accordance with heating the metal member 51. Thus, the surfaces of the metal member 51 and the plastic member 52 can be efficiently joined in the vicinity of the first surface 51a of the metal member 51 irradiated by the laser beams L1, L2. Further, since the laser beams L1, L2 are not focused on the first surface 52a of the plastic member 52, air bubble generation is suppressed, and the generation of surface irregularities in this plastic member 52 is effectively suppressed.

### Fourth Embodiment

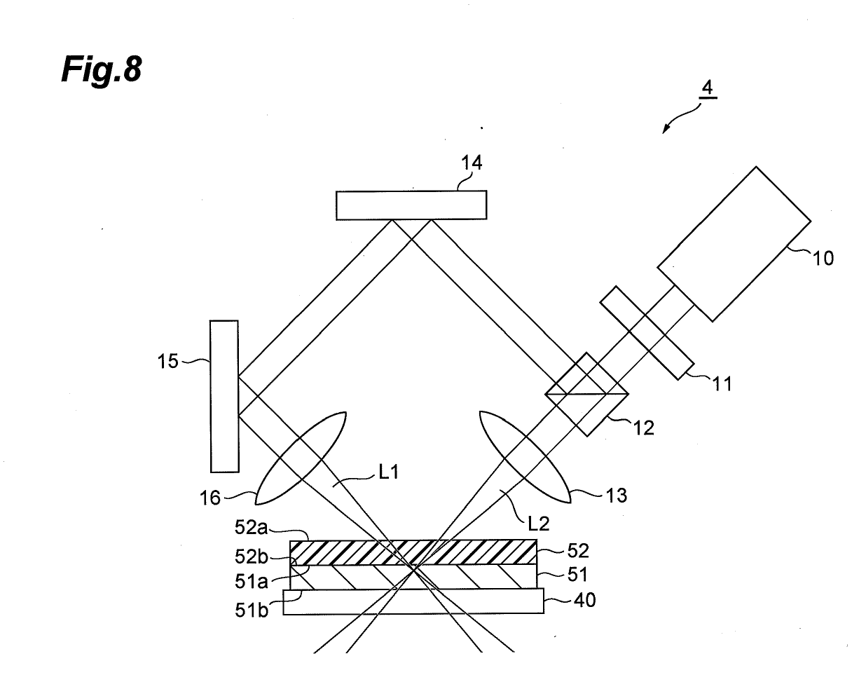

FIG. 8 is a view for explaining a fourth embodiment of the laser processing method according to the present invention. The laser processing apparatus 4 shown in FIG. 8 comprises a laser light source 10, diffractive optical element 11, beam splitter 12, first lens 13, first mirror 14, second mirror 15, and second lens 16. The laser processing apparatus 4 shown in FIG. 8 individually focuses a plurality of laser beams, and irradiates this plurality of laser beams onto an object to be processed comprising a metal member 51 and a plastic member 52. This structure is the same as the structure of the laser processing apparatus 1 shown in FIG. 1. However, such a laser processing apparatus 4 comprises a heater 40 that is in contact with the back face (second surface 51b) of the metal member 51. A ceramic heater is used as the heater 40.

In the laser processing method according to the fourth embodiment, the heater 40 is maintained at 200° C. and heats the metal member 51 prior to the laser beam being outputted from the laser light source 10. The laser beam is outputted from the laser light source 10 after the metal member 51 has been heated for a fixed period of time. The laser beam from the laser light source 10 is split into two laser beams L1, L2 by the beam splitter 12. The two split laser beams L1, L2 are respectively focused in the vicinity of the first surface 51a of the metal member 51 by way of the first lens 13 and the second lens 16. Consequently, the vicinity of the focal point is efficiently heated, and the surfaces of the metal member 51 and the plastic member 52 are joined. As described above, laser processing using the laser beam is carried out.

In this fourth embodiment, since the metal member 51 is heated in advance by the heater 40, there is no need to heat the metal member 51 using the laser beam outputted from the laser light source 10. Therefore, laser processing can be carried out by irradiating the laser on the interface between the metal member 51 and the plastic member 52 by way of the first surface 52a of the plastic member 52 while reducing the output intensity of the laser beam outputted from the laser light source 10. Further, the same as the first embodiment described above, in this fourth embodiment, after using the beam splitter 12 to split the laser beam outputted from the laser light source 10 into two laser beams L1, L2, these laser beams L1, L2 are focused from different directions by way of the first lens 13 and the second lens 16. As a result, the light intensity of the laser beams on the first surface 52a of the plastic member 52 is lower than when the laser beam is not split. Therefore, in the laser processing method according to the fourth embodiment, in addition to the light intensity of the laser beam being reduced on the first surface 52a (exposed surface) of the plastic member 52 the same as in the laser processing method according to the first embodiment, the output intensity of the laser beam from the laser light source 10 is also reduced. Therefore, in accordance with the fourth embodiment, for example, even in a case in which laser processing is carried out using a plastic member that is more susceptible to the generation of air bubbles in the vicinity of the surface, like a thin plastic member, the generation of air bubbles in the vicinity of the surface of the plastic member 52 is suppressed during laser processing. As a result, the generation of surface irregularities in the plastic member 52 can be effectively suppressed.

The embodiments of the present invention have been explained above, but the present invention is not limited to the above-described embodiments, and an assortment of variations is possible. For example, the heater 40 in the fourth embodiment can be disposed in the laser processing apparatus 2 and laser processing apparatus 3, which realize the laser processing methods according to the second or third embodiments. The method of using a mirror to change the optical path as in the first embodiment can be applied to another embodiment. More numerous laser beams can be focused in the vicinity of the first surface 51a of the metal member 51 by increasing the number of split beams.

In accordance with the present invention, it is possible to effectively suppress plastic member surface irregularities, which are highly likely to be generated when joining a thin plastic member to a metal member.

From the invention thus described, it will be obvious that the embodiments of the invention may be varied in many ways. Such variations are not to be regarded as a departure from the spirit and scope of the invention, and all such modifications as would be obvious to one skilled in the art are intended for inclusion within the scope of the following claims.

What is claimed is:

1. A laser processing method, comprising the steps of:
preparing a metal member having a first and second surfaces opposing each other, and a plastic member to be joined to the metal member, the plastic member having a first and second surfaces opposing each other;
placing the plastic member on the metal member such that the second surface of the plastic member makes contact with the first surface of the metal member; and
irradiating the two laser beams from mutually different directions toward a predetermined region on the first surface of the metal member, the two laser beams having focal points respectively set in the vicinity of the first surface of the metal member, and power densities, on the first surface of the plastic member, set to a level not more than a level at which the first surface of the plastic member does not melt, whereby the metal member and the plastic member are joined.

2. A laser processing method according to claim 1, wherein irradiation directions of the two laser beams are set such that respective beam spots of the two laser beams overlap on the first surface of the metal member.

3. A laser processing method according to claim 1, wherein irradiation directions of the two laser beams are set so as for the two laser beams to respectively reach the first surface of the metal member after passing through the plastic member.

4. A laser processing method according to claim 1, wherein, in a state in which the first surface of the metal member is in contact with the second surface of the plastic member, the focal points of the two laser beams are set so as to both be positioned inside a region where a distance from the interface between the metal member and the plastic member is equal to or less than ½ the thickness of the plastic member.

5. A laser processing method according to claim 1, wherein, in a state in which the first surface of the metal member is in contact with the second surface of the plastic member, the focal points of the two laser beams are set so as to both be positioned inside a region where a distance from the interface between the metal member and the plastic member is 200 μm or less.

6. A laser processing method according to claim 1, wherein the focal points of the two laser beams are set so as to both be positioned inside the metal member.

7. A laser processing method according to claim 1, wherein the two laser beams are generated by splitting a laser beam that is outputted from a single laser light source.

8. A laser processing method according to claim 1, wherein the two laser beams have wavelengths different from each other.

9. A laser processing method according to claim 1, wherein the vicinity of the interface between the metal member and the plastic member, which is defined as a contact surface between the metal member and the plastic member, is heated from the metal member side.

10. A laser processing method according to claim 1, wherein intensity distributions of the two laser beams are respectively made uniform by a diffractive optical element.
